(19) United States
(12) Patent Application Publication
(10) Pub. No.: US 2026/0145687 A1
(43) Pub. Date: May 28, 2026

(54) VERIFICATION OF OPERATIONAL REQUIREMENTS FOR AUTONOMOUS OR SEMI-AUTONOMOUS VEHICLES

(71) Applicant: Torc Robotics, Inc., Blacksburg, VA (US)

(72) Inventors: Florian Wittl, Stuttgart (DE); Dimitrios Tzempetzis, Stuttgart (DE); Christos Kostoglou, Stuttgart (DE)

(21) Appl. No.: 18/958,536

(22) Filed: Nov. 25, 2024

(51) Int. Cl. B60W 50/00

(52) U.S. Cl. CPC B60W 50/0098; B60W 2050/0016

(57) ABSTRACT

A system for verifying and validating operating requirements for an autonomous vehicle is provided. The system includes at least one memory configured to store programmed instructions and at least one processor configured to execute the programmed instructions. The programmed instructions cause the at least one processor to receive operational data that represents an operation of the autonomous vehicle and operating condition(s) for the autonomous vehicle; execute, based on the operational data, a state machine comprising at least a first and second state that share operating requirement(s) of the autonomous vehicle that may be evaluated under a same operating condition, determine, for one of the first and second state during execution of the state machine, whether the operating requirement(s) have been met, and cause the at least one processor to update, during execution of the state machine, the state machine based on state transitions between the first and second state.

### TECHNICAL FIELD

The field of the disclosure relates generally to autonomous and semi-autonomous vehicles, and more particularly, to verifying and validating operating requirements for autonomous and semi-autonomous vehicles utilizing state machines.

### BACKGROUND

Efforts are ongoing to provide autonomous or semi-autonomous driving capabilities to vehicles. The specific capabilities being developed for a particular vehicle may be defined by operating requirements for the vehicle during its operation as an autonomous or semi-autonomous vehicle. In some cases, the operating requirements are further defined by various automotive standards, which may require verification and validation in order to ensure that the vehicle is operating correctly during its operation as an autonomous or semi-autonomous vehicle. However, traditional methods of verification and validation, which focus mostly on vehicle testing for individual operating requirements, is impractical for development projects with limited timing and cost constraints.

There is consequently a need to ensure that the specific operating requirements defined for a vehicle can be met without excessive outlays in time and cost.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a system for verifying and validating a plurality of operating requirements for an autonomous vehicle is provided. The system includes at least one memory configured to store programmed instructions and at least one processor configured to execute the programmed instructions. When the programmed instructions are executed, the at least one processor is caused to receive operational data that represents an operation of the autonomous vehicle and one or more operating conditions for the autonomous vehicle. The programmed instructions further cause the at least one processor to execute, based on the operational data, a state machine comprising at least a first and second state that share one or more operating requirements of the autonomous vehicle that may be evaluated under a same operating condition of the one or more operating conditions. State transitions between the first and second state are triggered based on changes in the operational data. The programmed instructions further cause the at least one processor to determine, for one of the first and second state during execution of the state machine, whether the one or more operating requirements have been met. The programmed instructions further cause the at least one processor to update, during execution of the state machine, the state machine based on the state transitions between the first and second state.

In another aspect, a method of verifying and validating a plurality of operating requirements for an autonomous vehicle is provided. The method includes receiving operational data that represents an operation of the autonomous vehicle and one or more operating conditions for the autonomous vehicle. The method further includes executing, based on the operational data, a state machine comprising at least a first and second state that share one or more operating requirements of the autonomous vehicle that may be evaluated under a same operating condition of the one or more operating conditions. State transitions between the first and second state are triggered based on changes in the operational data. The method further includes determining, for one of the first and second state during execution of the state machine, whether the one or more operating requirements have been met. The method further includes updating, during execution of the state machine, the state machine based on the state transitions between the first and second state.

In another aspect, an autonomous vehicle is provided. The autonomous vehicle includes at least one sensor configured to generate operational data that represents an operation of the autonomous vehicle and one or more operating conditions for the autonomous vehicle. The autonomous vehicle further includes at least one processor. The at least one processor is further configured to execute, based on the operational data, a state machine comprising at least a first and second state that share one or more operating requirements of the autonomous vehicle that may be evaluated under a same operating condition of the one or more operating conditions. State transitions between the first and second state are triggered based on changes in the operational data. The at least one processor is further configured to determine, for one of the first and second state during execution of the state machine, whether the one or more operating requirements have been met. The at least one processor is further configured to update, during execution of the state machine, the state machine based on the state transitions between the first and second state.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6A is a block diagram of an example operating requirements verification and validation (V&V) system.

FIG. 6B is a block diagram of another example operating requirements V&V system.

FIG. 7 is a flowchart of a method of verifying and validating operating requirements for an autonomous vehicle.

FIG. 8 is a block diagram of a state machine used for verifying and validating operating requirements for an autonomous vehicle.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

There are problems that can arise when creating, implementing, and executing test cases associated with a complex product that includes multiple test platforms, for example, an L4 driverless vehicle. Because the number of operating requirements and the associated complexity of the requirements may be high, a typical operating design domain (ODD) analysis may not be a suitable platform to apply prior to implementing, executing, and analyzing test case results. Further, the typical ODD analysis may comprise an iterative process that may involve many team members with different skill sets and backgrounds.

Test cases are often implemented as free-form if-then-else statements. These test cases may then be executed in a specific environment that is defined to fit the conditions for an individual test case. However, this approach may be time consuming as there may need to be a defined step for every individual requirement and for every test platform as well as a specific implementation of that setup, before the execution of the test on that platform. One problem with this approach is that it is challenging to provide constructive feedback on the plausibility of the requirements. Typically the requirements are logically connected with each other as they may have been created from an analysis of use cases at the product level. Thus, the higher level logic and the connections between the requirements may be lost with an individual case-by-case analysis and with that, an important source of product validation and requirement quality check in the testing process may be missed.

With a product such as a level-4 vehicle, the behavior of the system under test (SUT) may change from one version to the next in ways that are difficult to predict. The result is that a test setup for each requirement may have to change as well from as the product version changes in order to accommodate for the changes in behavior of the product.

The pending application describes systems and a method for optimizing the test specification and evaluation requirements and ODD elements for the verification and validation (V&V) of a complex automotive product development. In the pending application, individual product requirements for the automotive product development inside of a state machine framework which reflects the complexity of conditions for checking the requirements.

Generally, the state machine in some embodiments includes, but is not limited to, states (i) which represent a collection of requirements, transitions (ii) which are assembled out of conditional expressions (e.g., events) that trigger a state change, and (iii) checks, which are the implementations of the individual requirement checks.

In some embodiments, creating the state machine may include, for example, (i) finding requirements that may be checked (e.g., implemented) under the same conditions within the ODD, and (ii) define ODD events or combinations that would leave the ODD boundaries of a state, therefore resulting in a state change.

In some embodiments, states include sub-states, where different ODD elements may be considered. One example is to have sub-states related to weather and/or lighting conditions in an emergency breaking state and/or a vehicle following state.

In one embodiment, a V&V system is described that verifies and validates a plurality of operating requirements for a vehicle, which may be an autonomous or semi-autonomous vehicle. The V&V system receives operational data that represents an operation of the vehicle and one or more operating conditions for the vehicle. For example, the operational data may include sensor data (simulated for, or captured from) the vehicle under different operating conditions (e.g., daytime, nighttime, rain, snow, etc.). The V&V system executes, based on the operational data, a state machine that includes at least two states. The two states share one or more operating requirements for the vehicle that may be evaluated under the same operating conditions. For example, the two states may share a vehicle following distance requirement for the vehicle during nighttime. In this embodiment, state transitions between the two states are triggered based on changes in the operational data. For example, the state changes between the two states may be triggered based on a change in distance between the vehicle and the vehicle being followed. During execution of the state machine, the V&V system determines, for one of the two states, if the operating requirements have been met. For example, the V&V system determines, for the state that is currently active based on the following distance, whether the operating requirements of the active state have been met. This framework enables the operating requirements for the vehicle to be evaluated quickly and efficiently without resorting to independent test cases for each operating requirement.

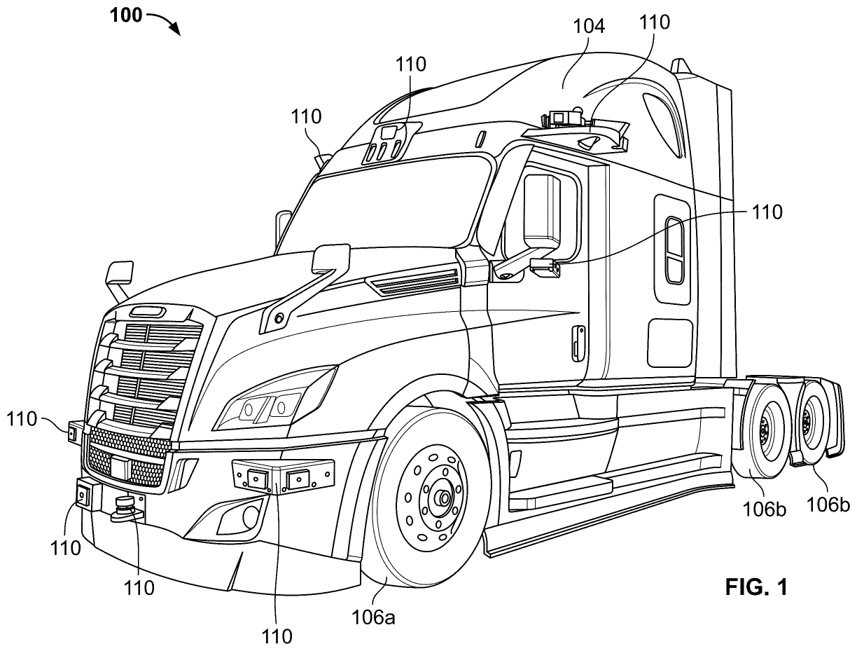

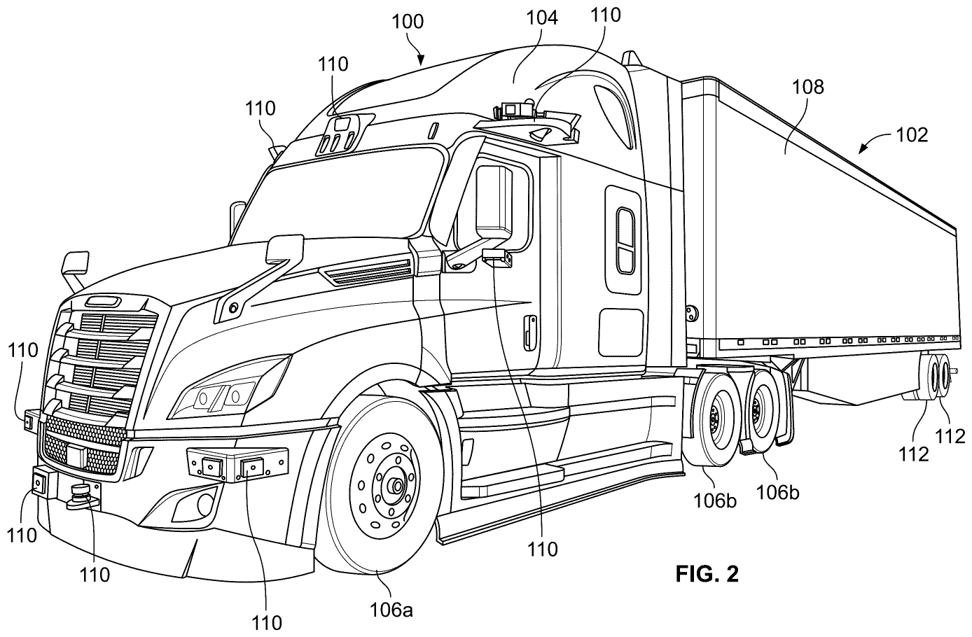

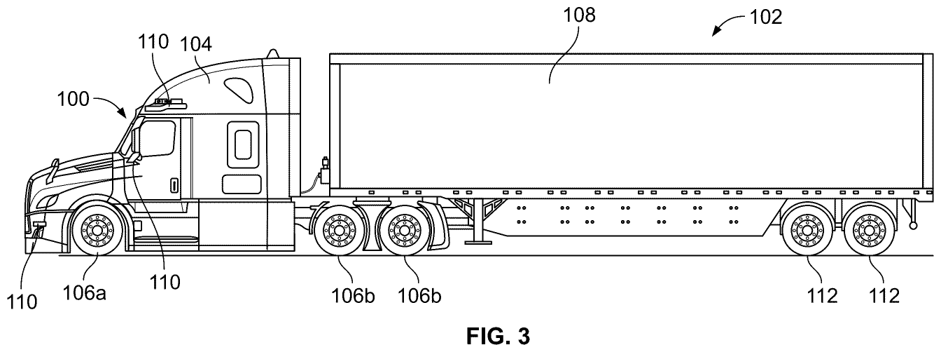

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releaseably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

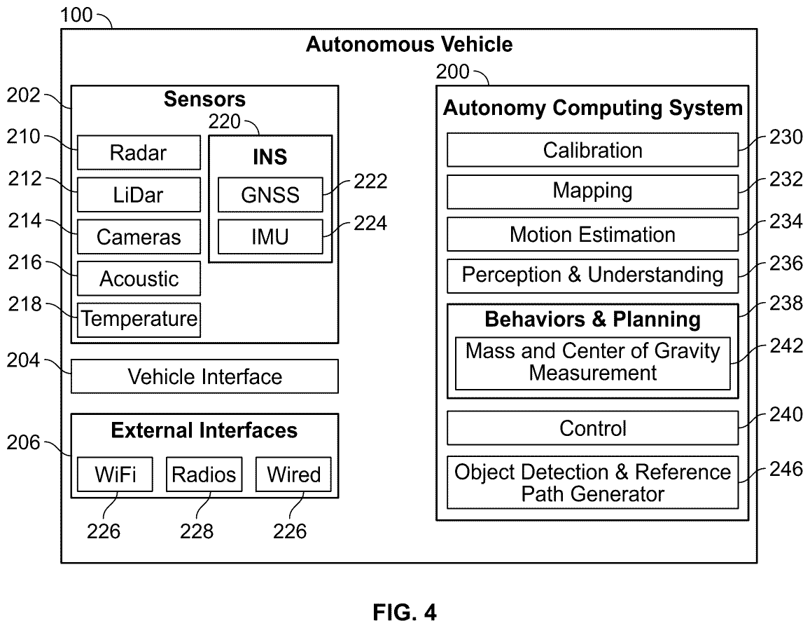

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

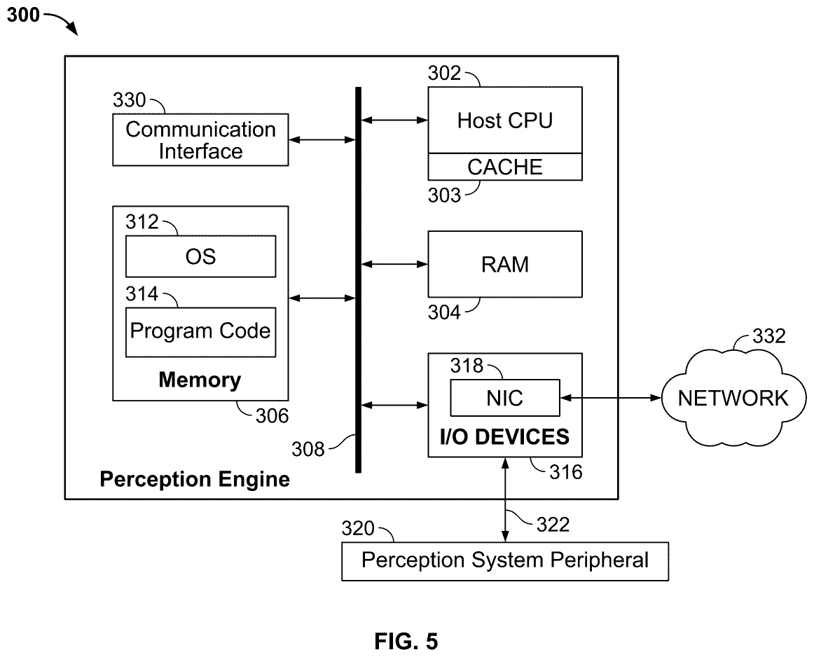

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

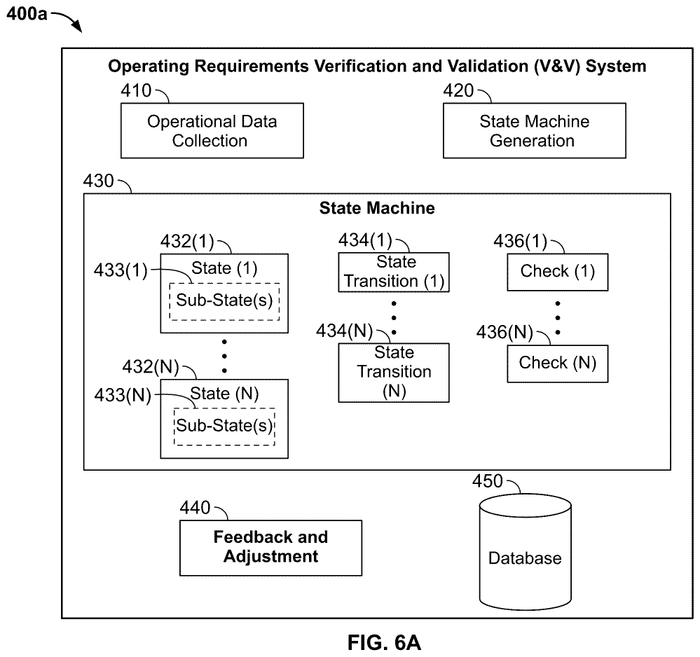

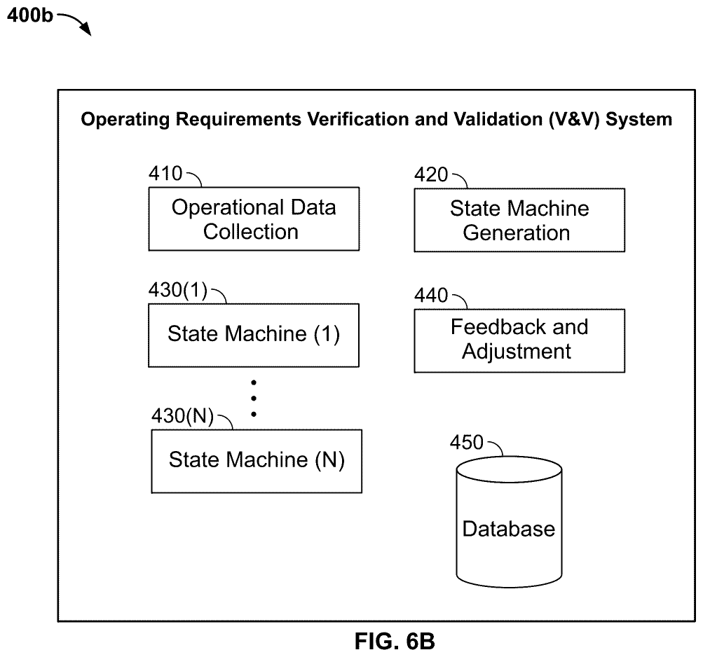

FIG. 6A is a block diagram of an example operating requirements V&V system 400a. FIG. 6B is a block diagram of another example operating requirements V&V system 400b. The V&V systems 400a, 400b (collectively referred to as V&V system 400) verifies and validates one or more operating requirements for a vehicle (e.g., the vehicle 100 as shown in FIGS. 1-4), which may be an autonomous or semi-autonomous vehicle. Examples of operating requirements include at least one of a following distance, a deceleration rate, an acceleration rate, a lane-keeping requirement, a speed requirement, and a turn rate.

In some embodiments, the V&V system 400 may be part of the vehicle 100 as shown in FIGS. 1-4. For example, the V&V system 400 may be included in the autonomy computing system 200 as shown in FIG. 4. In some embodiments, the V&V system 400 may be included in a remote server that communicates with the vehicle 100. For example, the V&V system 400 may be included in the program code 314 as shown in FIG. 5 that communicates with the vehicle 100 over the network 332.

As illustrated in in FIG. 6A, the V&V system 400 includes an operational data collection module 410, a state machine generation module 420 generating one or more state machines 430 including states 432(1)-432(N) (collectively referred to as states 432), state transitions 434(1)-434(N) (collectively referred to as state transitions 434), and checks 436(1)-436(N) (collectively referred to as checks 436), a feedback and adjustment module 440, and a database 450. It should be understood that the V&V system 400 can includes multiple state machines 430 as illustrated in FIG. 6B.

The operational data collection module 410 receives operational data that represents an operation of the vehicle 100 and one or more operating conditions for the vehicle 100. The one or more operating conditions are based on one or more of environmental conditions, geographic conditions, time-of-day, traffic, road infrastructure, speed, distance, roadway conditions, lateral motion, deceleration, acceleration, planned maneuvers, and emergency maneuver. Examples of the operational data include simulated data that simulates an operation of the vehicle 100 and/or one or more operating conditions, real-time data captured from the vehicle 100 under different operating conditions, sensor data generated by one or more sensors 202 (e.g., at least one of the RADAR sensor 210, the LiDAR sensor 212, the camera 214, the acoustic sensor 216, the temperature sensor 218, the INS 220, the GNSS receiver 222, the IMU 224, and data generated by other suitable sensors of the vehicle 100), and other suitable data representing an operation of the vehicle 100 and/or operating conditions. The operational data may be stored in the database 450.

State machine generation module 420 generates one more state machines 430 as further described below. In some embodiments, the state machine generation module 420 may determine one or more operating requirements that may be checked (e.g., implemented) under the same operating conditions within an ODD. The state machine generation module 420 may further define ODD events or combinations that would leave the ODD boundaries of a state, therefore resulting in a state change from that state to another state.

An ODD may refer to a set (e.g., one or more) of operating conditions that define when an automated system (e.g., an autonomous vehicle, a semi-autonomous vehicle or the like) can be safely operated. An ODD analysis may refer to a process of defining and analyzing operating conditions under which an automated system is safely engaged. In some examples, NHTSA uses a system of six top-level categories and many subcategories to define an ODD. ODDs are not static and require continuous iteration and refinement.

An ODD may include some ODD elements, including but are not limited to: environmental conditions (e.g., weather and atmospheric conditions like temperature, wind, visibility, precipitation, lighting, or the like), operational terrain (e.g., an autonomous vehicle's surroundings and projected path, including road features like slope, curvature, friction, or the like), infrastructure (e.g., availability and placement of navigation aids, traffic management devices, keep-out zones, or the like), rules of engagement (e.g., traffic laws, social norms, customary signaling procedures, or the like), time of day (e.g., when autonomous vehicle can operate, such as during the day or night, or the like), scenery (e.g., non-movable elements like traffic lights or the like), dynamic elements (e.g., movable elements like traffic or the like), and/or other suitable elements associated with operating conditions.

An ODD event may refer to an event that can occur within the operating conditions defined by an ODD. Examples of an ODD event include driver alertness, human commands (e.g., police pull-over or passenger distress), normal human interactions, operator takeover, cancellation, or redirect, operator status feedback, operator intervention latency, single operator supervision of multiple systems, operator handoff, loss of operator ability to interact with vehicle, and/or some combination thereof.

In some embodiments, the state machine generation module 420 may generate one or more state machines 430 via a modeling tool, a diagram tool (e.g., systems modeling language (SysML) to generate a SysML diagram), and/or a programming code. The generated state machines 430 may be stored in the database 450.

In some embodiments, the state machine generation module 420 may generate two or more state machines as further described with respect to FIG. 6B.

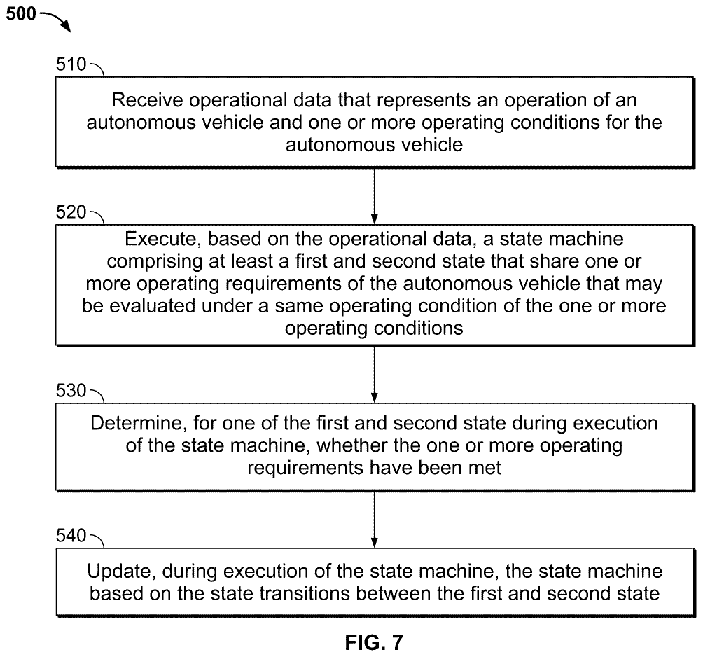

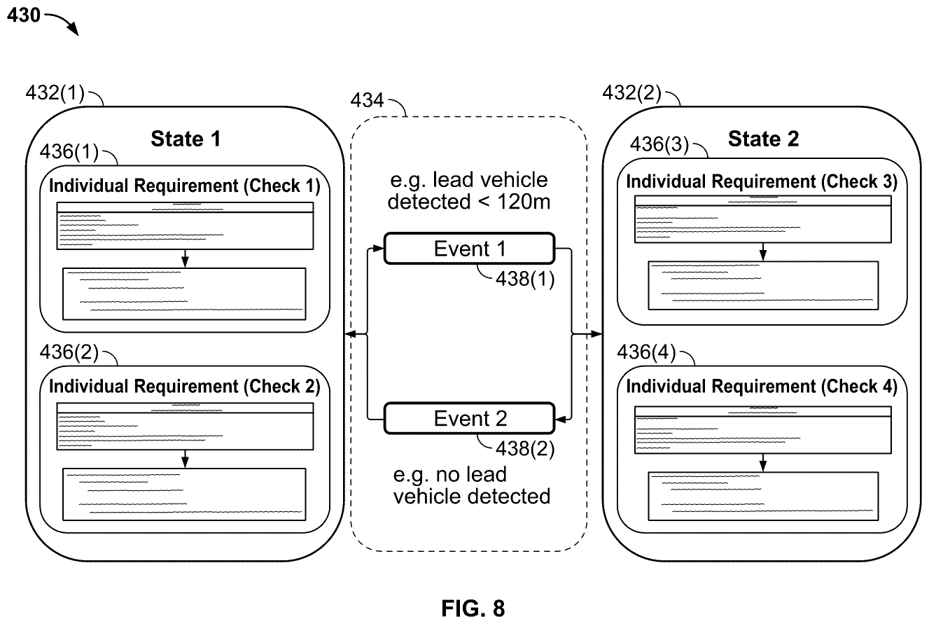

The state machine 430 may refer to a program or an algorithm (e.g., a behavior model, an artificial intelligent model, or another suitable mathematical model of computation) that models how a system (e.g., the vehicle 100) changes over time in response to events (e.g., signals, triggers, changes, or the like). In some embodiments, the state machine 430 may be represented as a standard SysML diagram. The state machine 430 includes states 432, state transitions 434, and checks 436. Examples of executing the state machine 430 are further described with respect to FIGS. 7-8.

States 432 represent a collection (one or more) of operating requirements. Each state 432 may include a respective collection of operating requirements. In some embodiments, the states 432 may share one or more operating requirements of the vehicle 100. For example, if the vehicle 100 is evaluated under at least one same operating condition, the states may share at least one operating requirement (e.g., the same operating requirement). In some embodiments, each of the states 432 may include one or more sub-states 433 (e.g., sub-states 433(1)-433(N) collectively referred to as sub-states 433). The states may share one or more sub-states in common. The one or more sub-states may include one or more operating requirements of the vehicle 100 that may be evaluated under the same operating condition. For example, sub-states related to operating requirements of weather/light conditions can be added or included in the states 432 having operating requirements of the emergency braking or simple vehicle following. In some embodiments, the states 432 may have different operating requirements or have at least one different operating requirement. For example, if the vehicle is evaluated under different operating conditions, the states 432 may have different operating requirements. Examples of the states 432 are further described with respect to FIGS. 7-8.

State transitions 434 may be assembled out of conditional expressions (e.g., trigger events) that trigger a state change from one state to another state. A trigger event may refer to occurrence of changes in the operational data (e.g., one or more operating conditions and/or the operation of the vehicle 100). Changes in the operational data may trigger state transitions between one state and another state. Similarly, sub-state transitions between the one or more sub-states may be triggered based on the changes in the operational data. It should be understood that the state transitions can occur across more than two states. For example, a first state 432(1) may transit to a second state 432(2) that may transit to a third state 432(3), and so forth. Examples of the state transitions 434 are further described with respect to FIGS. 7-8.

Checks 436 are implementations of each individual operating requirement associated with each state 432. For example, the state machine 430 can check each individual operating requirement and generates a result of check (e.g., a pass, a fail or not checkable) by evaluating an operation of the vehicle 100 using each individual operating requirement. Examples are further described with respect to FIGS. 7-8.

The feedback and adjustment module 440 sends a feedback to one or more components of the V&V system 400 and/or one or more components of the vehicle 100 based on data (e.g., state transitions 434 and/or results of checks 436) associated with the state machine 430. The feedback and adjustment module 440 also adjusts one or more components of the V&V system 400 and/or one or more components of the vehicle 100. For example, if the state transition 434 from a first state 432(1) to a second state 432(2) occurs, the feedback and adjustment module 440 may send a feedback to the autonomy computing system 200 to update an operation of the vehicle 100 so that the state machine 430 can generate a result of check 436 for the updated operation based on the operating requirements of the second state 432(2). The feedback and adjustment module 440 may also adjust (e.g., update) the state machine 430. For example, based on the results of the checks 436 for a specific state 432, the feedback and adjustment module 440 may remove, add, or replace one or more operating requirements for that state 432. As another example, based on the state transitions 434 from the first state 432(1) to the second state 432(2), the feedback and adjustment module 440 may remove, add, or replace operating requirements for the first state 432(1) or for the second state 432(2). In some embodiments, the feedback and adjustment module 440 may send a feedback to the state machine generation module 420 to refine or update the state machine 430 or generate a new state machine 430 based on a comparison between the check results of the state machine 430 and expected results and/or a comparison between the state transition 434 and expected state transition.

As illustrated in FIG. 6B, the V&V system 400 includes two or more state machines 430(1)-430(N) (collectively referred to as state machines 430) in addition to the operational data collection module 410, the state machine generation module 420, the feedback and adjustment module 440, and the database 450.

Each of the state machines 430(1)-430(N) includes states 432, state transitions 434, and checks 436 as described with respect to FIG. 6A. The multiple state machines 430(1)-430(N) may or may not depend on each other. In some embodiments, the state machines 430(1)-430(N) are independent, which provides advantage that independent state machines 430(1)-430(N) split the complexity and can be evaluated in parallel. In some embodiments, the state machines 430(1)-430(N) may depend on each other. For example, one state of a first state machine 430(1) may transit to one state of a second state machine 430(2) or 430(N) without excessive outlays in time and cost.

FIG. 7 is a flowchart of a method 500 of verifying and validating operating requirements for an autonomous vehicle. The method may be performed by the V&V system 400 (400a, 400b), the vehicle 100, and/or the computing system 300.

At block 510, the method 500 includes receiving operational data that represents an operation of the autonomous vehicle and one or more operating conditions for the autonomous vehicle. For example, with respect to FIGS. 6A-6B, the operating data collection module 410 may receive operational data that represents an operation of the vehicle 100 and one or more operating conditions for the vehicle 100.

At block 520, the method 500 includes executing, based on the operational data, a state machine comprising at least a first and second state that share one or more operating requirements of the autonomous vehicle that may be evaluated under a same operating condition of the one or more operating conditions. State transitions between the first and second state are triggered based on changes in the operational data. For example, with respect to FIGS. 6A-6B, the state machine(s) 430 may be executed based on the operational data (e.g., a current operation of the vehicle 100 and one or more current operating conditions) received from the operational data collection module 410, the state machine(s) 430 may determine two or more of operating requirements for a first state 432(1) and two or more operating requirements for a second state 432(2) based on the operational data. The first and second state 432 may share at least one operating requirement associated with one or more same operating conditions under the vehicle 100 may be evaluated. It should be understood that at least one operating requirement between the first and second state 432 is different to ensure an occurrence of a state transition. The state transitions 434 between the first and second state 432 are triggered based on changes in the operational data. For example, if the operational data changes (e.g., the operation of the vehicle 110 changes and/or one or more operating conditions change), the state machine(s) 430 may determine an occurrence of a trigger event. The state machine(s) 430 may determine the state transition 434 between the first state 432(1) and the second state 432(2) based on the trigger event (e.g., changes of the operational data).

At block 530, the method 500 includes determining, for one of the first and second state during execution of the state machine, whether the one or more operating requirements have been met. For example, with respect to FIGS. 6A-6B, if the first state 432(1) is currently active, the state machine(s) 430 may implement each operating requirement of the first state 432(1) by evaluating an operation of the vehicle 100 using each operating requirement of the first state 432(1). The state machine(s) 430 may generate results of checks 436 (e.g., a pass, a fail or not checkable) for each operating requirement of the currently active state 432(1). Based on the results of checks 436, the first state 432(1) can be determined whether the operating requirements of the first state 432(1) have been met. If a state transition 434(1) from the first state 432(1) to the second state 432(2) occurs, the second state 432(2) becomes currently active, the state machine(s) 430 may implement each operating requirement of the second state 432(2) by evaluating an operation of the vehicle 100 using each operating requirement of the second state 432(2). The state machine(s) 430 may generate results of checks 436 (e.g., a pass, a fail or not checkable) for each operating requirement of the second state 432(2). Based on the results of checks 436, the second state 432(2) can be determined whether the operating requirements of the second state 432(2) have been met. If a state transition 434(2) from the second state 432(2) to the first state 432(1), the first state 432(1) becomes currently active, the first state 432(1) can be determined whether the operating requirements of the first state 432(1) have been met based on the currently active operation data, as described above. In such way, the state machine(s) 430 enables the operating requirements for the vehicle 110 to be evaluated quickly and efficiently without resorting to independent test cases for each operating requirement.

At block 540, the method 500 includes updating, during execution of the state machine, the state machine based on the state transitions between the first and second state. For example, as illustrated in FIGS. 6A-6B, the feedback and adjustment module 440 may update the state machine(s) 430 based on the state transitions 434. For example, based on the state transitions 434 between the first state 432(1) to the second state 432(2), the feedback and adjustment module 440 may remove, add, or replace operating requirements for the first state 432(1) or for the second state 432(2). As another example, based on the results of the checks 436 for the first state 432(1) or the second state 432(2), the feedback and adjustment module 440 may remove, add, or replace one or more operating requirements the first state 432(1) or for the second state 432(2). In some embodiments, the feedback and adjustment module 440 may send a feedback to the state machine generation module 420 to refine or update the state machine(s) 430 or generate a new state machine(s) 430 based on a comparison between the check results of the state machine(s) 430 and expected results and/or a comparison between the state transitions 434 and expected state transitions.

FIG. 8 is a block diagram of a state machine 430 used for verifying and validating operating requirements for an autonomous vehicle (e.g., the vehicle 100). The state machine 430 has a first state 432(1) and a second state 432(2). For example, the two states 432 may share a vehicle following distance requirement for the vehicle 100. The first state 432(1) may include the vehicle following distance requirement and a speed requirement. The second state 432(2) may include the vehicle following distance requirement and a deceleration rate requirement. If the vehicle 100 is currently driving without a lead vehicle detected in a highway, the vehicle 100 is supposed to meet a speed limit of the highway. In this scenario, the first state 432(1) may be currently active. The state machine 430 may check if a currently active operation of the vehicle 100 meets each of the vehicle following distance requirement and the speed requirement. The state machine 430 may generate results of checks 436(1), 436(2) (e.g., a pass, a fail or not checkable) for each operating requirement of the first state 432(1). Based on the results of checks 436(1), 436(2), the first state 432(1) can be determined whether the operating requirements of the first state 432(1) have been met.

If a lead vehicle, followed by the vehicle is detected and a distance between the vehicle 100 and the lead vehicle is less than a threshold distance value (e.g., 120 meters), the vehicle 100 is supposed to decelerate its speed to increase the distance. In this scenario, the state machine 340 may determine an occurrence of a trigger event 438(1) indicating that a distance between the vehicle 100 and the lead vehicle is less than a threshold distance value (e.g., 120 meters), a state transition 434 from the first state 432(1) to the second state 432(2) occurs. Accordingly, the second state 432(2) becomes currently active. The state machine 430 may implement each operating requirement of the second state 432(2) by evaluating a currently active operation of the vehicle 100 using each operating requirement of the second state 432(2). The state machine 430 may generate results of checks 436(3), 436(4) (e.g., a pass, a fail or not checkable) for each operating requirement of the second state 432(2). Based on the results of checks 436(3), 436(4), the second state 432(2) can be determined whether the operating requirements of the second state 432(2) have been met.

If the lead vehicle changes its lane and no new lead vehicle is detected, the state machine 340 may determine an occurrence of a trigger event 438(2) indicating that no lead vehicle is detected, a state transition 434 from the second state 432(2) to the first state 432(1) occurs, which causes the first state 432(1) to be currently active. The first state 432(1) can be determined whether the operating requirements of the first state 432(1) have been met based on a currently active operation data of the vehicle 100. In such way, the state machine 430 enables the operating requirements for the vehicle 110 to be evaluated quickly and efficiently without resorting to independent test cases for each operating requirement.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for verifying and validating a plurality of operating requirements for an autonomous vehicle, the system comprising:
at least one memory configured to store programmed instructions; and
at least one processor configured to execute the programmed instructions which, when executed, cause the at least one processor to:
receive operational data that represents an operation of the autonomous vehicle and one or more operating conditions for the autonomous vehicle;
execute, based on the operational data, a state machine comprising at least a first and second state that share one or more operating requirements of the autonomous vehicle that may be evaluated under a same operating condition of the one or more operating conditions, wherein state transitions between the first and second state are triggered based on changes in the operational data;
determine, for one of the first and second state during execution of the state machine, whether the one or more operating requirements have been met; and
update, during execution of the state machine, the state machine based on the state transitions between the first and second state.

2. The system of claim 1, wherein:
the one or more operating requirements include at least one of a following distance, a deceleration rate, an acceleration rate, a lane-keeping requirement, a speed requirement, and a turn rate.

3. The system of claim 1, wherein:
the one or more operating conditions are based, at least in part, on one or more of environmental conditions, geographic conditions, time-of-day, traffic, road infrastructure, speed, distance, roadway conditions, lateral motion, deceleration, acceleration, planned maneuvers, and emergency maneuvers.

4. The system of claim 1, wherein the programmed instructions further cause the at least one processor to:
receive the operational data from the autonomous vehicle.

5. The system of claim 1, wherein the programmed instructions further cause the at least one processor to:
receive the operational data from the autonomous vehicle in real-time.

6. The system of claim 1, wherein:
the operational data comprises simulated data.

7. The system of claim 1, wherein:
the first and second state share one or more sub-states in common, the one or more sub-states including the one or more operating requirements of the autonomous vehicle that may be evaluated under the same operating condition, wherein sub-state transitions between the one or more sub-states are triggered based on the changes in the operational data.

8. The system of claim 1, wherein:
the operational data comprises data generated by at least one sensor the autonomous vehicle.

9. The system of claim 8, wherein the at least one sensor comprises at least one of a light detection and ranging sensor, a camera, and a radar sensor.

10. A method of verifying and validating a plurality of operating requirements for an autonomous vehicle, the method comprising:
receiving operational data that represents an operation of the autonomous vehicle and one or more operating conditions for the autonomous vehicle;
executing, based on the operational data, a state machine comprising at least a first and second state that share one or more operating requirements of the autonomous vehicle that may be evaluated under a same operating condition of the one or more operating conditions, wherein state transitions between the first and second state are triggered based on changes in the operational data;
determining, for one of the first and second state during execution of the state machine, whether the one or more operating requirements have been met; and
updating, during execution of the state machine, the state machine based on the state transitions between the first and second state.

11. The method of claim 10, wherein receiving the operational data further comprises:
receiving the operational data from the autonomous vehicle.

12. The method of claim 10, wherein receiving the operational data further comprises:
receiving the operational data from the autonomous vehicle in real-time.

13. The method of claim 10, wherein:
the operational data comprises simulated data.

14. The method of claim 10, wherein:
the first and second state share one or more sub-states, the one or more sub-states including the one or more operating requirements of the autonomous vehicle that may be evaluated under the same operating condition, wherein sub-state transitions between the one or more sub-states are triggered based on the changes in the operational data.

15. The method of claim 10, wherein:
the operational data comprises data generated by at least one sensor the autonomous vehicle.

16. The method of claim 15, wherein the at least one sensor comprises at least one of a light detection and ranging sensor, a camera, and a radar sensor.

17. The method of claim 10, wherein:
the one or more operating requirements include at least one of a following distance, a deceleration rate, an acceleration rate, a lane-keeping requirement, a speed requirement, and a turn rate.

18. The method of claim 10, wherein:
the one or more operating conditions are based, at least in part, on one or more of environmental conditions, geographic conditions, time-of-day, traffic, road infrastructure, speed, distance, roadway conditions, lateral motion, deceleration, acceleration, planned maneuvers, and emergency maneuvers.

19. An autonomous vehicle, comprising:
at least one sensor configured to generate operational data that represents an operation of the autonomous vehicle and one or more operating conditions for the autonomous vehicle; and
at least one processor configured to:
execute, based on the operational data, a state machine comprising at least a first and second state that share one or more operating requirements of the autonomous vehicle that may be evaluated under a same operating condition of the one or more operating conditions, wherein state transitions between the first and second state are triggered based on changes in the operational data;
determine, for one of the first and second state during execution of the state machine, whether the one or more operating requirements have been met; and
update, during execution of the state machine, the state machine based on the state transitions between the first and second state.

20. The autonomous vehicle of claim 19, wherein:
the one or more operating requirements include at least one of a following distance, a deceleration rate, an acceleration rate, a lane-keeping requirement, a speed requirement, and a turn rate, and/or
the one or more operating conditions are based, at least in part, on one or more of environmental conditions, geographic conditions, time-of-day, traffic, road infrastructure, speed, distance, roadway conditions, lateral motion, deceleration, acceleration, planned maneuvers, and emergency maneuvers.
